(19) United States
(12) Patent Application Publication
(10) Pub. No.: US 2024/0363323 A1
(43) Pub. Date: Oct. 31, 2024

(54) DESORPTION DEVICE, SYSTEM AND A METHOD USING SUCH IN GASEOUS SAMPLE ANALYSIS

(71) Applicant: KARSA OY, Helsinki (FI)

(72) Inventors: Aleksei SHCHERBININ, Helsinki (FI); Jyri MIKKILÄ, Helsinki (FI); Verner HEMMILÄ, Helsinki (FI); Hans-Jurg JOST, Helsinki (FI)

(21) Appl. No.: 18/309,565

(22) Filed: Apr. 28, 2023

(51) Int. Cl. H01J 49/04; H01J 49/00

(52) U.S. Cl. CPC H01J 49/049; H01J 49/0031

(57) ABSTRACT

The present disclosure concerns a desorption device including a mesh structure forming a mesh filter the mesh being formed by back-bone material being coated by gas adsorbing and/or absorbing absorbent. The present disclosure concerns also a desorption device hosting device to hold such desorption device in sampling, and a system as well as a chemical analysis method using such desorption devices in the sampling of a sample being analyzed.

### BACKGROUND OF THE INVENTION

### Field of the Invention

In general, the present disclosure of the embodiments of the invention is pertinent to chemical analysis of gaseous species, particularly air and its composition in detail. More particularly the present disclosure concerns desorption device for the detection and analysis of gaseous components of a sample being collected from the sampling-site atmosphere, the sample being analyzed by a mass-analysis device of the system in accordance of the analyzing method. The desorption device belongs to the mass analyzer device system, as being indicated to concern about the desorption device in the preamble part of an independent claim concerning the independent claim about the embodied system that uses such a desorption device, in accordance of the claimed method in an independent method claim.

### Description of the Related Art

In general Composition of an air sample can be analyzed in many ways. There are devices as such for such routine-type analysis to study air samples, even in detail, to find out the chemical composition of a sample, sometimes even the materials in different phases that are present in the sample.

However, small abundances of the species in the sample that may be small itself in a prerequisite manner, near the detection limit of the analyzing equipment may be not sufficiently reliable in certain critical application aiming detection of hazardous substances and their presence in small amounts. In one interesting traditional method to sample particles as such is based on filtration, in which a filter matrix is used to collect particulate matter on to the structures of the filter matrix, which can be analyzed after the collection as such.

During the proceeding collection of the sample, the filter in duty is getting clogged, little by little, while the particles are collected to the filter from the medium flow that is flowing through the filter. That happens, because of the collected particles occupancy being increasing between the filter structure constituents, which leads to diminishing space for the medium flow to flow through the filter between the structures, so causing a choking kind of an effect in a certain sense.

The filter clogging leads to pressure drop increase over the filter, which to be compensated, needs more medium to flow in a higher rate by a pressure increase. There is an ultimate limit how high the pressure can rise, in compelling the medium through the filter, the limit being determined by the structural terms of the filter as such. Consequently by the increasing pressure drop, less medium can flow to the filter, and in certain point, it is not any more rational to compel further sampled material through the filter, in avoidance of the filter material mechanical breakup, but also resuspension of the already collected particles back into the flow that has also a flooding effect to the filter in the further parts.

Another particle sampling method is based on particle mass and the inertia of it, when the particles in the carrying medium of the flow are suddenly compelled to change the flow direction. In such an occurrence, the particles are willing to continue their state of their motion, as a wanted effect, to get the particles out of the medium flow, to hit to a collection substrate and impact onto the substrate, that is called often as an impactor plate. Such a device is called impactor and the flow setting geometry implementation with the impactor plate is called as an impactor stage, in which there is a nozzle or channel to form a jet flow that makes a sudden turn to side direction while the inertia of the particles maintains the passage of the particles to a collection plate at a certain pre-designed distance to the nozzle.

In addition to the traditional impactor as such being disclosed above in a manner a skilled person to recognize an impactor as such, there are also versions being developed from the described traditional impactors to virtual impactors, which differ in such from the traditional impactors above in that feature that instead of the unite collection plate of a tradition impactor stage, there is a collection plate being used as such, but the collection plate has a small hole for the particles to go through, at the position where the particles would have been impacted. and would be piling in the corresponding flow geometry of a traditional impactor. In virtual impactor the gas flow as the medium as such is so separated from the particles, which therefore are concentrated into the flow going through the virtual impactor stage so formed.

The particulate sample that is collected can be analyzed for example by microscope inspection, in a chemical analysis as such, but also by means of mass spectrometry, which can achieve very low detection limits in measures of the original sample. Also other analysis methods can be used as such.

Sometimes it is not the particles as the interest of the sampling. There are also sampling devices such as desorption tubes, that are filled with granules of porous particles in a tube, through which the medium with the gaseous components in it are led to flow through. According to the diffusion of the gases, the gaseous components of the medium are absorbed into the granules, which are heated afterwards when analyzing the sample so being collected.

What is problematic is the particles in the flow so to get onto the gas sample holding granules, which increases the detection limit by the so caused noise by the chemicals contained in the particles. Another problem rises from the handling of the granules as such, which may compromise the sample, if not being extremely cautious, especially within in detection of low concentration species.

### SUMMARY OF THE INVENTION

According to the present disclosure of the embodiments of the invention, a new device to take gas samples has been developed to solve or at least mitigate the problems in gas analysis, particularly for samples of low or ultra-low abundant gaseous species, being detected reliably in an embodied system using a mass analyzer in the detection and chemical analysis of such samples and the constituents therein.

A desorption device being embodied according to the present disclosure of the invention in accordance of an independent claim 1 solves or at least mitigates the problems of the known gas sampling in concentrating and collecting of the sample, that is sampled to contains low or ultra-low abundant gaseous species, into the sample being collected.

A chemical analysis system according to an independent claim directed to the gas analysis system using a desorption device according to present disclosure in claim 1 is also disclosed.

A sampler being a part of the analysis system can be a system element in which the desorption devices can be hosted and hold in the system while taking the sample. Such an embodied sampler (called also as a host or hosting device) can comprise a holder for the desorption devices and/or its embodied variants, which are embodied as disks, (i.e., the filter).

The embodied filters can comprise also as particle removal means an impactor plate to form an impactor stage part to collect particles on to the plate. An impactor stage also comprises an ensemble of flow setting orifices for the stage for at least one jet of the flow, and at a stopping distance to correspond a 50% collection efficiency cut size an impactor plate, to collect particles (i.e., collection plate) on to the impactor plate.

According to a further alternative variant the impactor plate is a plate of a virtual impactor (stage) with an ensemble of holes at the middle of a corresponding ensemble of flow jets to correspond the collection location, but in a virtual impactor to guide particles from the flow to a separate channel, which can be embodied as a further stage, leading to a collection by filtration or impaction.

According to the present disclosure of the embodiments, and embodied desorption device comprises a mesh structure forming a mesh filter the mesh being formed by back-bone material being coated by gas adsorbing and/or absorbing absorbent. The flow being in contact with the mesh-wire filter surface encounters/creeps (creep along the surface in impactor plate embodiments) the surface so that the adsorbing and/or absorbing material can absorb gases from the flow, according to the embodied flow geometry.

According to an embodiment of the present disclosure the embodied desorption device has such a back-bone material, which is selected from an ensemble of the following materials: a metal, a noble metal, a coated metal, plastics, ceramics, glass, a composition of the just previously mentioned materials.

According to an embodiment of the present disclosure the embodied desorption device has a form of disk to allow the sample flow to penetrate through the disk with the absorbent material coated mesh-wire filter structure.

According to an embodiment of the present disclosure the embodied desorption device has a disk part that has a central portion on the surface in respect of the oncoming flow or part thereof that is a virtual impactor plate or a traditional impactor plate, to separate particles from the sampled gas.

The aerial ratio of the impactor plate area to the filtering area can be between 0 to 25, alternatively between 0 to 20 or between 0 to 10, the end values being included to the embodied intervals.

According to an embodiment of the present disclosure the embodied desorption device has the gas adsorbing and/or absorbing mesh filter in a ring-shaped area surrounding the central part positioned impactor plate and/or virtual impactor plate.

According to an embodiment of the present disclosure the embodied desorption device has the impactor plate or virtual impactor plate that surrounds the central part with the mesh filter with the adsorbing and/or absorbing material.

According to an embodiment of the present disclosure the embodied desorption device has such a desorption device that has a rectangular geometry for residence time increase in the channel of the sample flow.

According to an embodiment of the present disclosure the embodied desorption device has a disk part with the mesh filter that disk part is detachable from the other parts of the desorption device, so to facilitate the detachable part being analyzed in a different chemical analysis than the other part or parts of the desorption device.

According to an embodiment of the present disclosure the embodied desorption device has such a hydraulic diameter of the mesh filter (with the adsorbing and/or absorbing material) or the outer diameter of the gas collecting area that is less than 150 mm, advantageously less than 80 mm even further advantageously less than 50 mm, preferably more than 25 mm.

The adsorbing and/or absorbing material (here called as sorbent) on the mesh-wires of the desorption device can have a chemical composition for the adsorbing and/or absorbing targeted sample material that may vary depending on application and targeted sample constituents, and the sorbent material may include: polymers, zeolites, sieves and activated carbon and carbon based adsorbents. In one embodiment variant the adsorbing and/or absorbing material comprises poly(2,6-diphenyl-p-phenylene oxide). The chemical composition can be dedicated for certain gaseous substances, and/or small droplet liquid adsorption.

According to an embodiment of the present disclosure the embodied desorption device has a rectangular form in the flow geometry to have increased the flow-throughput area and/or exposure for the adsorption/absorption by diffusion to occur, in comparison to circular form.

According to such an embodiment variant, the collection area is D² (squared)>πD²/4, i.e., for a square shaped rectangular with side dimension of D in comparison to circular having the diameter of D.

According to an embodiment of the present disclosure the embodied desorption device comprises a plurality of stages of the desorption device, i.e., filter stages in a cascade geometry to form a stack as in series in respect to the flow through the stack.

According to an embodiment of the present disclosure the embodied desorption device has in the stack of desorption devices an ensemble of stages, comprising at least one of at least one type of the following stages:
stage having mere filter,
stage with a traditional impactor plate and filter,
stage with virtual impactor stage and fitter.

The sampling rate, when collecting the sample, through the desorption device can be less than 1000 standard liters per minute, alternatively less than 500 standard liters per minute, alternatively less than 350 standard liters per minute, further alternatively less than 100 standard liters per minute, or less than 50 standard liters per minute, however more than 1 standard liters per minute. The desorption device's filter parts of the mesh-wire having the wire orientation, layering and/or the packing density considerations, being selected according to the flow rate particle and/or gaseous species concentration in respect to the pressure drop at the flow rate, so that the allowed flow rate could be between 1 and 1000 standard liters per minute, the packing density and pressure drop allowing for the flow rate in question during the sampling without estimated damage to the desorption disk filtering parts.

According to the present disclosure an embodied desorption device system is using a desorption device according to the present disclosure and a mass analyzer.

According to an embodiment, the mass analyzer of the system is of a type of APITOF-mass spectrometer (Atmospheric Pressure Interface Time of Flight mass spectrometer).

However, the mass analyzer can be alternatively at least one of the alternatives in the following: orbitrap mass spectrometer, ion trap mass spectrometer, quadrupole spectrometer or ion mobility spectrometer.

According to an embodiment of the present disclosure, an embodied system according to the present disclosure can comprise an ionization device located at the entry before the mass analyzer to ionize substances released from the desorption device at the thermal treatment made by a heater in the system.

According to an embodiment the system comprises a heater for the thermal treatment of the desorption devices and/or parts thereof.

According to an embodiment of the present disclosure the embodied desorption device system comprises for the mass analyzer a chemical library of the species being recognized.

According to an embodiment of the present disclosure the embodied desorption device has such a chemical library that has records on isotopic masses and the relative abundances variations, to be used in the system in recognition of the low or ultra-low abundant species. According to an embodiment variant, the library comprises a cumulative database of the already recognized gaseous substances with their isotopic abundances of the elements, to be used as a tag and/or in the tracing of the origin of the species.

According to an embodiment of the present disclosure the embodied desorption device-based method of analyzing gaseous samples, wherein the sampling being made by using a desorption device according to an embodiment of the present disclosure, comprises:
directing gas flow from which to take the sample through said desorption device operating as a gas filter,
accumulating gaseous species of the flow to the gas adsorbing/absorbing material on the mesh wire in the accumulating phase by adsorption and/or absorbing,
measuring pressure drop over the filter in the flow during the sampling period,
stopping sampling at the end of the sampling period,
exposing the filter to thermal treatment in the thermal treatment temperature,
leading the released species in the thermal treatment to a mass analyzer,
acquiring the masses of the species,
recognizing the species in a comparison to species in a species library.

According to an embodiment of the present disclosure the embodied desorption device-based method of analyzing gaseous samples, the sampling is stopped as based on the pressure drop increase threshold value.

According to an embodiment of the present disclosure the embodied desorption device-based method of analyzing gaseous samples the thermal treatment temperature is less than 400° C., advantageously less than 300° C., further advantageously less than 150° C., but preferably over 50° C., or even further preferably over 30° C.

According to an embodiment of the present disclosure the embodied desorption device-based method of analyzing gaseous samples in the accumulation phase particles are removed by impacting them to an impactor plate or alternatively to a virtual impactor orifice.

According to an embodiment of the present disclosure the embodied desorption device-based method of analyzing gaseous sample, the sampling and the thermal treatment are alternating for a particular filter, the filter being flushed therebetween the switching by a flush period.

According to an embodiment of the present disclosure the embodied desorption device-based method of analyzing gaseous samples the flush period is determined by a threshold of a species level in the flush flow by the mass-analyzer signal. According to an embodiment variant, the flush flow abundance concentration of the flushed species is used in rejecting the desorption disk for the sampling further.

Further examples on the embodiments of the present disclosure are disclosed in the dependent claims.

“To comprise” has been used in the following disclosure as an open expression.

Expressions such as “a first”, “a second”, “a third”, etc. in context of an entity are used merely to differentiate a first entity from a second entity and/or third entity.

Expression “a number of” is referring to an ensemble of entities present in the ensemble by the number, which may be also embodied by a set number or a fork of such.

Expression “a plurality of” is referring to such an ensemble of entities that has two or more members in the ensemble, whereas expression “ensemble” refer to such an ensemble that can have one or more members in the ensemble.

In the following, the degree of adsorption and absorption may be very hard to distinguish and quantify in practice, and therefor expression adsorption and/or absorption has been used for the sorption in question for the sampling of gases to the coating chemical as sorption agent, even so that sorbent is referring to a chemical or substance that is capable to either or both adsorption and adsorption. Adsorption has been considered as a surface phenomenon as such and does not necessary penetrate to the coating through the surface, to the bulk of the sorbent material (the coating in the embodiments), while absorption involves the whole volume of the material (of the coating that may be porous in some embodiments of the coating materials as sorbents), although adsorption can be preceding phenomena to absorption.

### BRIEF DESCRIPTION OF THE DRAWINGS

In the following, examples of embodiments of the invention of the present disclosure are illustrated by the drawings in which same reference numerals are used in denoting to same or same kind of objects in various figures (Fig.). Although same numeral reference may be used to denote to a slightly different object between the figures, a skilled person in the art knows from the embodiments and the illustrated context as explained in the specification the difference between the objects, if any. In the following,

FIG. 1 illustrates a desorption device according to the present disclosure as a side-ways projection,

FIG. 1a illustrates an alternative round geometry of the desorption device of FIG. 1 as on a top view,

FIG. 1b illustrates an alternative rectangular geometry of the desorption device of FIG. 1 as on a top view,

FIG. 1c illustrates the desorption device side-view with mesh-structure illustration,

FIG. 2 illustrates the mesh structure details of embodiments in FIG. 1, FIG. 1a, FIG. 1b and FIG. 1c,

FIG. 3 illustrates an embodied desorption device according to alternative embodiment variants with impactor plate,

FIGS. 3a, 3b and 3c illustrate top views of the alternative embodiment geometry examples of FIG. 3,

FIG. 4 illustrate a side view geometry of an alternative desorption device with impactor plate area,

FIGS. 4a, 4b and 4c illustrate and top views of the alternative embodiment geometry examples of FIG. 4,

FIG. 5 illustrates mesh-wire structure of embodied desorption device with views from several direction as observed,

FIG. 6 illustrates an embodied desorption device host with the desorption device holders with alternative options for a stacked filtration,

FIGS. 6a and 6b illustrate alternative stage geometries, to corresponding desorption device holders with the host with the respectively fit geometries,

FIGS. 7, 7a, 7b and 7c illustrate embodied alternatives of the desorption device with virtual impactor plate geometry in synergy to FIGS. 3, 3a, 3b, 3c, 4, 4a, 4b and 4c,

FIG. 8 illustrates an embodied system of the present disclosure using an embodied desorption device and the corresponding desorption device holder, and

FIG. 9 illustrates a sampling method according to the present disclosure.

### SYMBOLS

101 desorption device as a disk plate,
102 desorption device's mesh wire,
102b the mesh wire back-bone.
102c the mesh wire coating on the back-bone,
h thickness of a desorption device as a filter in general,
D diameter or side length of a desorption device,
d inner diameter or side length of a desorption device,
F outer diameter of the mesh wire with the coating,
f the back-bone diameter of the mesh wire 102,
p mesh wire screen pore size between the back bones in the structure,
301 desorption device with impactor plate and alternatives thereof,
301v desorption device with virtual impactor plate and alternatives thereof,
301f mesh wire part/portion of the desorption device in embodiments with impactor plate and/or virtual impactor plate
400 desorption device with impactor plate and alternatives thereof,
600 desorption device host, also as a hosting device
601 desorption device holder in the host, also in alternative geometries,
v virtual impactor hole, denote also to the diameter of it, used also in a reference numeral in referring to virtual impactor (part),
800 desorption device system for the sampling,
801 hardware of the system, including in alternatives also automation, desorption device handling
μp Computer with microprocessor, its software and memory
MS Mass analyzer, such as a mass spectrometer, for example API-TOF, orbitrap, ion trap, quadrupole or ion mobility spectrometer
Lib Library for the elements, their isotopes and/or recognized chemical species,
SW dedicated software to control the system, mass analyzer and the library.

### DETAILED DESCRIPTION

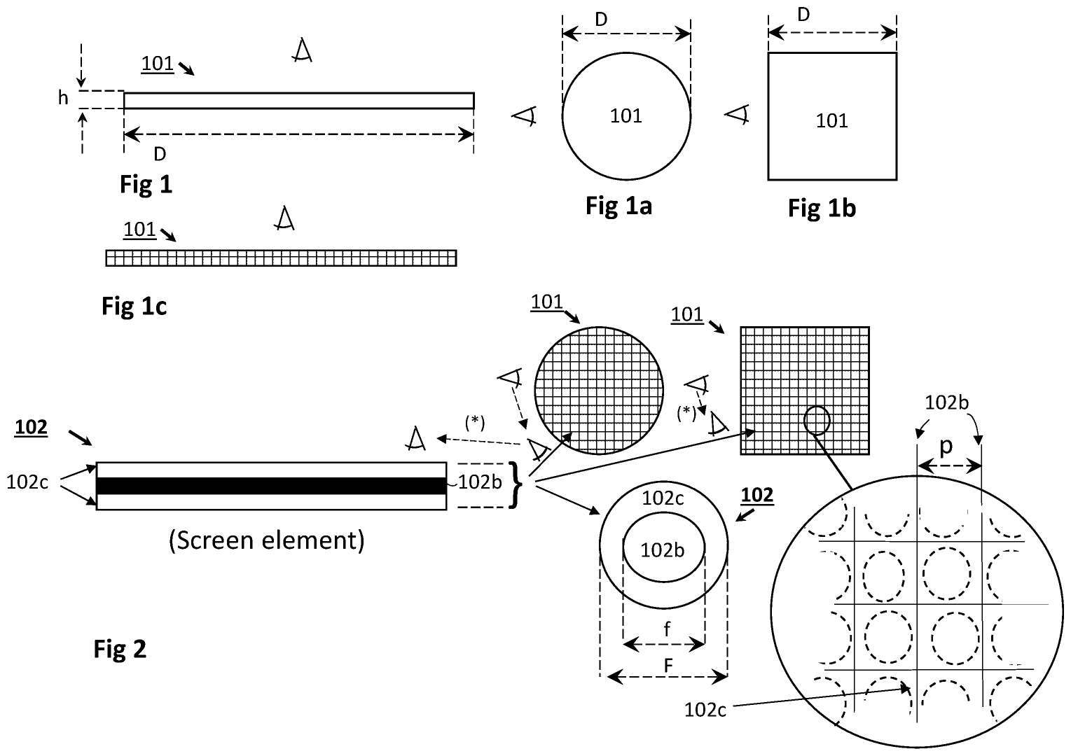

In the following examples of the embodiments of the present disclosure are explained in a further detail with reference to the illustrations appended to the present specification. FIG. 1 illustrates a side-view projection of a desorption device according to an embodiment of the present disclosure. The desorption disk has been illustrated as a planar disk, with diameter of D, which can be between 20 mm to 150 mm, depending on the sampling specific sampling line in question, as well as on the flow being used in the sampling. The view markings refer to the two alternative geometries of round (FIG. 1a) and rectangular shapes (FIG. 1b) of the desorption device 101. According to an embodiment, the plate-geometry has been embodied as practical to handle, especially in automated sampling media handling hardware apparatus (801). Although square shape embodied in FIG. 1b, a skilled person in the art realizes that also other, elongated rectangular shapes are also possible, with an embodiment specific hydraulic diameter D, which may differ from an individual side of the rectangular disk. The mesh structure has been illustrated also in FIG. 1c from a side view.

FIG. 2 illustrates a desorption device's 101 mesh wire structure details with several indicated views. The mesh wire itself has been illustrated by the screen element, a portion of which as schematically illustrated by the item 102. Such a mesh wire has a back-bone wire 102b, which is coated by the coating 102c, which coating has the gas adsorbing and/or absorbing task in the desorption device structure. The mesh wire 102 has been illustrated via an elongated and cross-sectional views.

In FIG. 2 there is also an illustration about the pore size p of the mesh-wire structure, as illustrated via the mesh wire distance. The coating 102c in the illustration is exaggerated for illustrative purposes only, and the shape of the pores may vary and differ from the schematic example. However, the quantity p can approximate the hydraulic diameter of the pores in the mesh filter in as an effective manner so that a skilled person in the art knows the effective pore size to set the flow volume of the sample flow, which can be constituted by a pump in the system for the sampling.

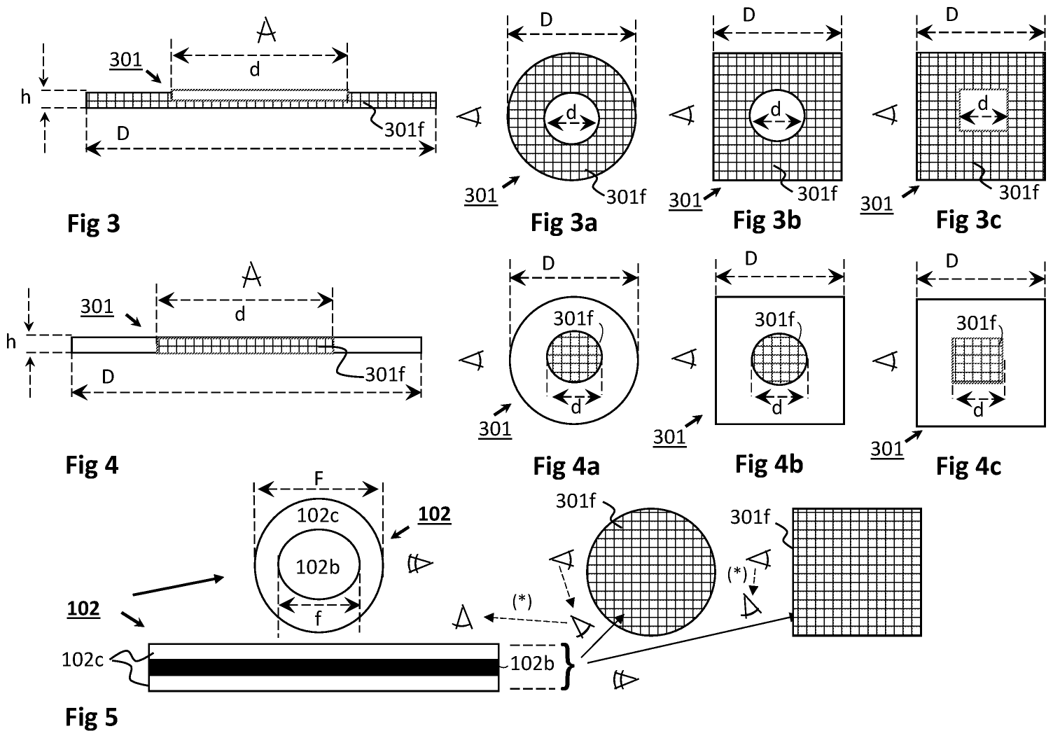

FIG. 3 illustrates an alternative structure of a desorption device having its outer diameter of D according to the present disclosure of the embodiments. The impactor plate, with diameter of d, can be solidly attached on or onto the mesh filter (with the thickness h), so that the part of the sample being collected can be taken for analysis by cutting apart, for example. According to an alternative embodiment, the impactor plate can be detachable, so that the mesh filter part can be handled and analyzed separately, but are more easily to detach from the mesh filter.

By the embodiments with the impactor plate, the gas absorption sample in the mesh wire filter does not contain the particles that are impacted on to the impactor plate, so prolonging the sampling of the gaseous species, as the impaction collection of the particles prevents and/or delays the mesh filter clogging. In addition, the particles to be collected can be selected by the impactor stage geometry and the corresponding inertia of the particles. FIGS. 3a, 3b and 3c illustrate geometric variants of the desorption device 301 in respect to the desorption device shape and the impactor plate. The impactor plate side in a rectangular square geometry has a dimension of the side d, and the desorption device in rectangular square geometry has a dimension of the side D.

In FIGS. 3 to 3c the desorption device 301 with its alternatives have the impactor plate at the middle, illustrated by non-patterned area. A skilled person in the art knows immediately as based on the embodied location on filter, where to arrange the impactor nozzle for the impactor stage and to which distance from the plate, when the desired collection efficiency for a certain sized particles are known, so that the particles are collected on to the plate. The gaseous stream is then freed from the collected particles onto the stage and the plate, and can be absorbed to the absorption device's absorbent, before getting out of the reach of the mesh-wire part of the filter, the mesh-wire part being denoted by reference numeral 301f, illustrated by the checkered patterns.

In FIGS. 4, 4a, 4b, and 4c the parts of the impactor plate and the filter parts 301f of the desorption device 301 are complement in respect to the corresponding parts shown in FIGS. 3, 3a, 3b and 3c. Therefore, a skilled person reading the disclosure of the FIG. 3 embodiments knows also the structures of FIGS. 4a, ab and 4c. In FIG. 4. the mesh-wire filter part 301f is positioned at the middle, and forming a through-structure for the flow to propagate to the next stage or to pump. The view geometries are indicated in same way as in the FIGS. 3 to 3c.

FIG. 5 is illustrative of wires of the mesh-wire desorption device in a further detail, in synergy with the markings of FIG. 2. The pore size is similar as illustrated in FIG. 2, also for the mesh-wires of FIG. 3, FIG. 4, FIG. 5 and also for FIG. 7, FIG. 7a, FIG. 7b and FIG. 7c.

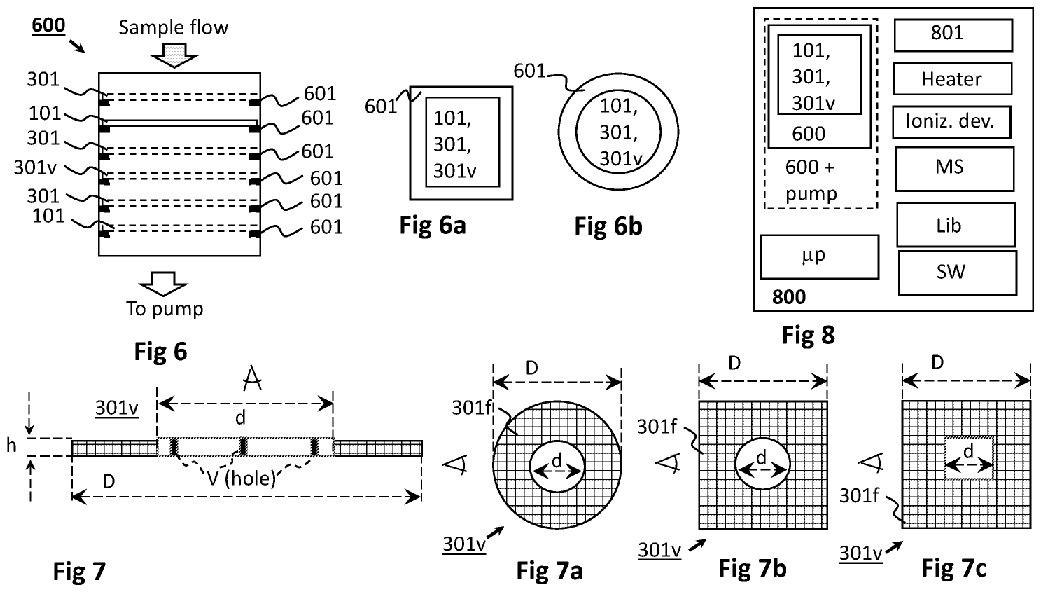

FIG. 6 is illustrating a desorption device 101, 301, 301v host 600 with the desorption device holders 601 to hold embodied desorption devices. In the FIG. 6 there is at least one desorption device 101 (or the desorption device 301 or the desorption device 301v) in the sample collection of the gaseous sample, to form a stack, which can be a mono stack (one desorption device) or a multi-stack (two or more desorption devices). Although not shown, a skilled person in the art can provide impactor stages with the required distance to plate and nozzle diameters for impactor collection of certain particle sizes with a desired collection efficiency. According to an embodiment variant, virtual impactor plates with the orifices therethrough can be utilized as impactor nozzles for next stages, in suitable part.

FIG. 6 is a side view, indicative of a sample flow to the desorption disk host 600 and further to a pump to constitute the sample flow. FIG. 6a is indicative a rectangular sample holder 601 geometry and FIG. 6b an alternative round sample holder 601 geometry for respectively shaped and embodied desorption devices 101, 301, 301v. In a squared geometry it is possible to provide approximately 30% longer residence time in a desorption device's residence for the exposure than in round geometry with diameter of D corresponding the square side length D. The number of desorption devices (101, 301, 301v) as desorption stages is not limited as such, but can be one or more of stages which is embodied in the example as 1 to 6 (the dashed lines indicative of alternative number of the desorption devices, which can be of the same type (101, 301 or 301v) or alter between the items 101, 301, 301v, in a suitable combination according to the user).

FIG. 7 illustrates an embodied desorption device with a virtual impactor plate at the middle of the desorption device 301v. The virtual impactor plate with the diameter d in FIG. 7 at the middle of the desorption device can have the orifice v (i.e., hole) at the middle of the plate, but can be also embodied alternatively so that there are several parallel orifices at end side through the virtual impactor plate. Especially in such embodiments that are similar to the impactor plates of FIGS. 4a, 4b, 4c, the orifices can be designed to surround the middle part of the desorption device so embodied. In such an embodiment the number of the orifices can be selected to follow a symmetry for even flow distribution and particle removal, at the parts of the virtual impactor disk, for the next stage to collect the gas sample to the adsorbing and/or absorbing material of the mesh-wire filter.

The FIGS. 7a, 7b and 7c illustrates desorption devices as illustrated in FIGS. 3a, 3b and 3c respectively, but instead of impactor plate as in FIGS. 3a, 3b and 3c, in FIGS. 7a, 7b and 7c by illustration with virtual impactor plates for the embodied alternatives of the desorption device 301v.

FIG. 8 is illustrating a desorption device system for collecting and/or analyzing the collected samples. The desorption devices 101, 301, 301v can be positioned into the collection duty by the host 600, which can alternatively comprise also the pump (indicated by the dashed line and expression 600+pump). The system can be computer controlled as indicated by the marking up, which denotes to presence of microprocessor and the peripherals in the computer and its operation as such, with the software. In addition, the memory of the computer in the control, can have also a dedicated software package SW, which can comprise soft ware to control the mass analyzer MS of the system, as well as the library Lib to maintain a data base on the elements and the isotopes, as well as an accumulating database part of the already recognized species, and/or their origin as based on the constituent substances and their isotope abundances in the substances. According to an embodiment the library Lib can comprise also isotope ratios of the elements in the previously recognized species. According to an embodiment, the system 800 can comprise also an ionization device as such for preparing the analytes for the mass analyzer MS. The ionization device can be a suitable ionization device based on one or more ionization mechanisms as such or a multiple ionization mechanisms based device taking into account adaptively different ionization characteristics of chemical ionization behavior of substances under interest from the samples.

The item 801 is denoting to sample handling as such, for the alternative automation, but also to the desorption by thermal treatment in the thermal treatment temperature, if the heater is in the embodiment as a part of the sample handling related device, to release from the desorption device the absorbed substances from the absorption material 102c on the desorption device's mesh-wire. In a variant, also the impactor plates or the virtual impactor plates can be thermally treated to release materials from them, separately or in combination with the respective stages containing the gaseous sample species in the adsorbing and/or absorbing material.

The thermal treatment can be made by a heater (Heater, FIG. 8) as such that can be any suitable thermal treatment device as such or a suitable variant of such heater. Ceramic or metallic heater using heat radiation to release the substances, or infrared heater, or microwave, or by means of inductive heating, the flow passing through the heating chamber of the heater can be used to carry substances from the heater to the mass analyzer in the system, via ionization parts when present in such an embodiment.

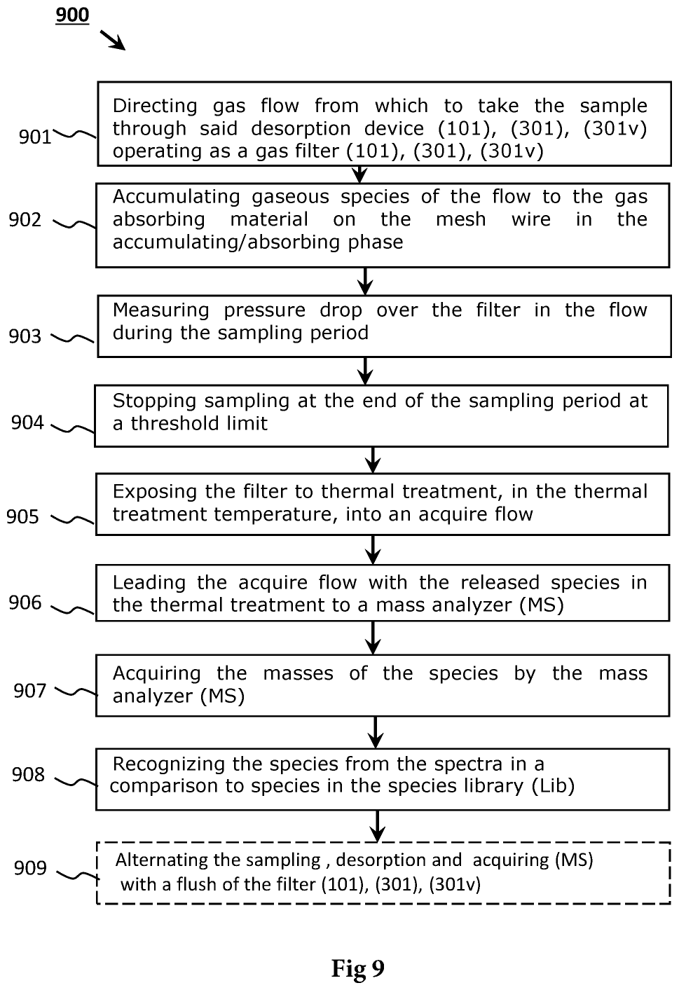

FIG. 9 illustrates a method 900 of analyzing gaseous samples, wherein the sampling being made by using at least one desorption device 101, 301, 301v according to an embodiment. In the method there are method steps comprising:
directing 901 a gas flow from which to take the sample through said desorption device 101, 301, 301v operating as a gas filter to collect gases from the flow,
accumulating 902 the gaseous species from the flow to the gas adsorbing and/or absorbing material 102c on the mesh wire 102 in the accumulating phase by adsorbing and/or absorbing,
measuring 903 pressure drop over the filter in the flow during the sampling period,
stopping sampling 904 at the end of the sampling period at a threshold limit, which can be based on timing (by computer control of the system 800 and/or by a pressured drop observance (in the computer control of the system 800,
exposing 905 the filter (i.e., the desorption disk and/or the part with filter media of the mesh-wire 301f to thermal treatment in the thermal treatment temperature to an acquire flow for the desorption the released species, in the system part 801,
leading 906 the acquire flow with the released species therein, from the thermal treatment, to a mass analyzer,
acquiring 907 the masses of the species by a mass analyzer MS, which can be a suitable mass spectrometer to gas analysis as such, for example an APIT-TOF mass spectrometer as such, or another suitable mass spectrometer of a known type,
recognizing 908 the species from the acquired mass analyzer spectra in a comparison to species in a species library Lib.

According to an embodiment variant of the method 900, the sampling can be stopped as based on the pressure drop increase threshold value as the threshold limit, or as based on a cumulative gas volume, although the mesh wire filter were not clogging. In such embodiment the samples can be standardized, and the further volume would not compromise flushing the filter and the already collected gases, so optimizing the yield of rare abundance of the gaseous species being collected.

The thermal treatment temperature in the method can be less than 400° C., advantageously less than 300° C., further advantageously less than 150° C., but preferably over 50° C.

In the method 900 according to an embodiment, in the accumulation phase particles are removed by impacting them onto an impactor plate or alternatively to a virtual impactor orifice on virtual impactor plate to a further stage for collection as removal from disturbing the gaseous species analysis in a later face.

According to an embodiment in the method 900 the gas sampling and thermal treatment of the desorption device are alternating 909 for a particular filter so that the filter being flushed therebetween the switching of the release and collection of the gases by a flush period. In a variant embodiment of the method 900 the flush period can be determined by a predetermined threshold value of a species level in the flush flow, as determined by the mass-analyzer signal.

1. A desorption device comprising a mesh structure forming a mesh filter the mesh being formed by back-bone material being coated by gas adsorbing and/or absorbing sorbent.

2. The desorption device of claim 1 wherein the back-bone material is selected from an ensemble of the following materials: a metal, a noble metal, a coated metal, plastics, ceramics, glass, a composition of the just previously mentioned materials.

3. The desorption device of claim 1, wherein the desorption device has a form of disk to allow penetration of the sample flow through the desorption device.

4. The desorption device of claim 1, wherein the desorption device has a disk part that has a central portion in respect of the oncoming flow or part thereof that is a virtual impactor plate or a traditional impactor plate, to separate particles from the sampled gas.

5. The desorption device of claim 4, wherein the gas adsorbing and/or absorbing mesh filter has a ring-shaped area surrounding the central part positioned impactor plate and/or virtual impactor plate.

6. The desorption device of claim 4, wherein the impactor plate or virtual impactor plate surrounds the central part with the mesh filter with the adsorbing and/or absorbing material.

7. The desorption device of claim 1, wherein the desorption device has a rectangular geometry for residence time increase in the channel.

8. The desorption device according to claim 1, wherein the desorption device has a disk part with the mesh filter that is detachable from the other parts of the desorption device, so to facilitate the detachable part being analyzed in a different chemical analysis than the other part or parts.

9. The desorption device according to claim 1, wherein the hydraulic diameter of the mesh filter is less than 150 mm.

10. The desorption device having in the coating a chemical composition comprising at least one of the following materials:
polymer-based compounds
carbon-based compounds
oxygen-containing compounds.

11. The desorption device according to claim 1, wherein the filter and the filter holder has a rectangular form in the flow geometry to have increased the flow-throughput area and/or exposure for the absorption by diffusion to occur.

12. The desorption device hosting device of claim 1, further comprising a plurality of filter stages held by a holder in a cascade geometry to form a stack in series in respect to the flow through the stack.

13. The desorption device hosting device comprising in the stack of desorption devices of claim 12 an ensemble of stages, comprising at least one of at least one type of the flowing stages on the holder:
stage having mere filter,
stage with a traditional impactor plate and filter,
stage with virtual impactor stage and fitter.
a pump in addition to the holder of a filter stage.

14. An analyzing system of gas samples, using a desorption device according to claim 1 and a mass analyzer.

15. An analyzing system of gas samples, using a desorption device according to claim 1 and a mass analyzer, the analyzing system comprising a desorption device hosting device of claim 1, further comprising a plurality of filter stages held by a holder in a cascade geometry to form a stack in series in respect to the flow through the stack.

16. The analyzing system of claim 14, further comprising an ionization device located at the entry before the mass analyzer to ionize substances released from the desorption device at the thermal treatment.

17. The analyzing system of claim 14, wherein the mass analyzer is of a type of APITOF-mass spectrometer,

18. The analyzing system according to claim 14, wherein the mass analyzer is at least one of the alternatives in the following:
orbitrap mass spectrometer
ion trap mass spectrometer
quadrupole mass spectrometer
ion mobility spectrometer

19. The analyzing system according to claim 14, wherein the system comprises for the mass analyzer a chemical library of the species being recognized.

20. The analyzing system according to claim 14, wherein the chemical library has records on isotopic masses and the relative abundances variations, to be available for use in the system in recognition of the low or ultra-low abundant species.

21. Method of analyzing gaseous samples, wherein the sampling being made by using the desorption device of the system of claim, the method comprising
directing gas flow from which to take the sample through said desorption device operating as a gas filter,
accumulating gaseous species of the flow to the gas adsorbing and/or absorbing material on the mesh wire in the accumulating phase by adsorbing and/or absorbing,
measuring pressure drop over the desorption device as the filter in the flow during the sampling period,
stopping sampling at the end of the sampling period at a threshold limit,
exposing the filter to thermal treatment in the thermal treatment temperature to an acquire flow for the desorption,
leading into acquire flow with the released species in the thermal treatment to a mass analyzer,
acquiring the masses of the species by a mass analyzer,
recognizing the species from the spectra in a comparison to species in a species library.

22. The method of claim 21, wherein the sampling is stopped as based on the pressure drop increase threshold value as the threshold limit.

23. The method of claim 21, wherein the thermal treatment temperature is less than 400 C.

24. The method according to claim 21, wherein in the accumulation phase particles are removed by impacting them to an impactor plate or alternatively to a virtual impactor orifice on virtual impactor plate.

25. The method according to claim 21, wherein the sampling and thermal treatment are alternating for a filter, the filter being flushed therebetween the switching by a flush period.

26. The method according to claim 21, wherein the flush period is determined by a threshold of a species level in the flush flow by the mass-analyzer signal.
